(19) United States
(12) Patent Application Publication
(10) Pub. No.: US 2012/0100458 A1
(43) Pub. Date: Apr. 26, 2012

(54) ION-CONDUCTING MICROPARTICLE AND METHOD OF MANUFACTURING THE SAME, ION-CONDUCTING COMPOSITE, MEMBRANE ELECTRODE ASSEMBLY (MEA), AND ELECTROCHEMICAL DEVICE

(75) Inventors: Kenji Kishimoto, Tokyo (JP); Kazuaki Fukushima, Kanagawa (JP); Takuro Hirakimoto, Kanagawa (JP)

(73) Assignee: SONY CORPORATION, Tokyo, JP (JP)

(21) Appl. No.: 13/382,261

(22) PCT Filed: Jul. 7, 2010
(86) PCT No.: PCT/JP2010/061512

§ 371 Date: Jan. 4, 2012

(30) Foreign Application Priority Data
Jul. 15, 2009 (JP) 2009-166293

(51) Int. Cl. H01M 8/10; C07F 9/30; C07F 7/18; C07F 9/48; B82Y 99/00

(52) U.S. Cl. 429/494; 556/428; 556/405; 977/948

(57) ABSTRACT

There are provided an ion-conducting microparticle including an ion-dissociative group and exhibiting an affinity for a fluorine-containing resin, and a method of manufacturing the same, an ion-conducting composite including the ion-conducting microparticle, a membrane electrode assembly (MEA) including the ion-conducting composite as an electrolyte, and an electrochemical device such as a fuel cell. A reacting molecule 13, which includes, in only one end, a second reacting group 14 capable of being bonded to a first reacting group 12, and includes, in a main part and/or the other end, an atom group 5 having an affinity for a fluorine-containing resin, acts on a material microparticle 11 including an ion-dissociative group 3 and the first reacting group 12 on a surface of a base-material microparticle 2, and a reformed group 4, which is bonded at only one end to the surface of the base-material microparticle 2, and includes, in a main part and/or the other end, the atom group 5 having an affinity for a fluorine-containing resin, is introduced into the surface of the base-material microparticle 2 by a reaction between the first reacting group 12 and the second reacting group 14 to form an ion-conducting microparticle 1.

### TECHNICAL FIELD

The present invention relates to an ion-conducting microparticle including an ion-dissociative group and exhibiting an affinity for a fluorine-containing resin, and a method of manufacturing the same, an ion-conducting composite including the ion-conducting microparticle, a membrane electrode assembly (MEA) including the ion-conducting composite as an electrolyte, and an electrochemical device such as a fuel cell.

### BACKGROUND ART

Since fuel cells have high energy conversion efficiency and do not produce environmental pollutants such as nitrogen oxides, research and development of the fuel cells as power supplies have been actively carried out. Moreover, in recent years, as portable electronic devices such as notebook personal computers and cellular phones have become more sophisticated and multifunctional, there is a tendency that the portable electronic devices consume more power, and great expectations are placed on fuel cells as power supplies ready for portable electronic devices having such a tendency.

In the fuel cell, a fuel is supplied to an anode to be oxidized, and air or oxygen is supplied to a cathode to be reduced, and in the whole fuel cell, the fuel is oxidized by oxygen. At this time, chemical energy of the fuel is efficiently converted into electrical energy, and the electrical energy is extracted. Therefore, the fuel cell has a characteristic that unless the fuel cell is broken, as long as the fuel is supplied to the fuel cell, the fuel cell is allowed to continue to be used as a power supply.

Various kinds of fuel cells have been proposed or prototyped, and some of the fuel cells have been put in practical use. These fuel cells are classified according to used electrolytes into alkaline fuel cells, phosphoric acid fuel cells, molten carbonate fuel cells, solid oxide fuel cells, polymer electrolyte fuel cells (PEFCs), and the like. Specifically, the PEFCs are suitable as portable power supplies, because as an electrolyte is a solid, there is no possibility that the electrolyte is scattered, and the PEFCs are allowed to operate at a lower temperature than other types of fuel cells, for example, approximately 30° C. to 130° C., and the starting time is short.

FIG. 8 is a sectional view illustrating an example of a configuration of a fuel cell formed as a PEFC. In a fuel cell 20, an anode (a fuel electrode) 22 and a cathode (an oxygen electrode) 23 facing each other are bonded to respective surfaces of a hydrogen-ion (proton)-conducting polymer electrolyte membrane 21 to form a membrane electrode assembly (MEA) 24. In the anode 22, a porous anode catalyst layer 22b including polymer electrolyte particles having hydrogen-ion (proton) conductivity and catalyst particles having electronic conductivity is formed on a surface of a gas-permeable current collector (a gas diffusion layer) 22a made of a porous conductive material such as a carbon sheet or carbon cloth to form a gas diffusion electrode. Moreover, in the cathode 23, likewise, a porous cathode catalyst layer 23b including polymer electrolyte particles having hydrogen-ion (proton) conductivity and catalyst particles having electronic conductivity is formed on a surface of a gas-permeable current collector (a gas diffusion layer) 23a made of a porous support such as a carbon sheet to form a gas diffusion electrode. The catalyst particles may be particles made of only a catalyst material, or may be composite particles including a catalyst material supported by a carrier.

The membrane electrode assembly (MEA) 24 is sandwiched between a fuel channel 31 and an oxygen (air) channel 34, and is mounted in the fuel cell 20. During power generation, in the anode 22, the fuel is supplied from a fuel inlet 32, and is discharged from a fuel outlet 33. In the meantime, a part of the fuel passes through the gas-permeable current collector (gas diffusion layer) 22a to reach the anode catalyst layer 22b. As the fuel of the fuel cell, various combustible materials such as hydrogen and methanol may be used. In the cathode 23, oxygen or air is supplied from an oxygen (air) inlet 35, and is discharged from an oxygen (air) outlet 36. In the meantime, a part of oxygen (air) passes through the gas-permeable current collector (gas diffusion layer) 23a to reach the cathode catalyst layer 23b.

For example, in the case where the fuel is hydrogen, hydrogen supplied to the anode catalyst layer 22b is oxidized on anode catalyst particles by a reaction represented by the following reaction formula (1) to supply electrons to the anode 22.

2H₂→4H⁺+4e⁻ (1)

The generated hydrogen ions H⁻ are transferred to the cathode 23 through the polymer electrolyte membrane 21. Oxygen supplied to the cathode catalyst layer 23b reacts with hydrogen ions transferred from the anode on cathode catalyst particles by a reaction represented by the following reaction formula (2) to be reduced, and then electrons are taken from the cathode 23.

O₂+4H⁺+4e⁻→2H₂O (2)

In the whole fuel cell 20, a reaction represented by the following reaction formula (3) obtained by combining the reaction formulae (1) and (2) occurs.

2H₂+O₂→2H₂O (3)

Since a high-pressure container for storage is necessary for gas fuels such as hydrogen, the gas fuels are not suitable for downsizing of fuel cells. On the other hand, liquid fuels such as methanol has an advantage that liquid fuels are easily stored; however, since fuel cells of a type in which hydrogen is taken out of a liquid fuel by a reformer has a complicated configuration, the liquid fuels are not suitable for downsizing of fuel cells. Compared to these fuel cells, direct methanol fuel cells (DMFCs) in which methanol is directly supplied to an anode without being reformed to react have characteristics that the fuel is easily stored, the configuration thereof is simple, and the fuel cell is easily downsized. In related art, most of the DMFCs are used in combination with PEFCs, and have been studied as a kind of PEFC, and highest expectations are placed on the DMFCs as power supplies for portable electronic device.

In related art, as a material of the hydrogen-ion-conducting polymer electrolyte membrane 21, perfluorosulfonic acid-based resins such as Nafion (a registered trademark of E. I. du Pont de Nemours and Company) are typically used. Nation (a registered trademark) is made of a polymer including a perfluorinated hydrophobic molecular skeleton and a perfluorinated side chain including a hydrophilic sulfonic acid group. In Nafion (a registered trademark), hydrogen ions dissociated from the sulfonic acid group are diffused and transferred through, as a channel, water taken in a polymer matrix to exhibit hydrogen-ion conductivity. Therefore, a Nafion (a registered trademark) membrane exhibits high hydrogen-ion conductivity in a wet state where the Nafion (a registered trademark) membrane sufficiently absorbs water.

However, in a state with the water content is low, hydrogen-ion conductivity of the Nafion (a registered trademark) membrane is abruptly reduced. Moreover, since water taken in the polymer is maintained in a state where the water is phase-separated from a hydrophobic polymer skeleton, the Nafion (a registered trademark) membrane is unstable, and the moisture state thereof greatly varies with temperature, and temperature dependence of hydrogen-ion conductivity is high. Moreover, water is lost by evaporation at high temperature, and water is frozen at low temperature; therefore, to prevent these situations, a temperature range where the fuel cell is allowed to operate is limited. Further, the Nafion (a registered trademark) membrane has low performance of inhibiting the permeation of methanol, and in the DMFC using the Nafion (a registered trademark) membrane, a decline in power generation performance due to methanol crossover is pronounced. Moreover, the material cost of fluorosulfonic acid-based polymers is typically high, thereby causing an increase in cost of electrochemical devices using them, for example, fuel cells.

Therefore, PTL 1 which will be described later proposes using, as the material of the hydrogen-ion-conducting electrolyte membrane, a carbonaceous material derivative formed by introducing a proton dissociative group into a carbonaceous material predominantly including a carbon cluster, more specifically a carbon cluster with a specific molecular structure such as fullerene. It is to be noted that in PTL 1, “carbon cluster” is an aggregate predominantly consisting of carbon atoms, and formed by bonding several carbon atoms to several hundred carbon atoms together irrespective of kind of carbon-to-carbon bonding, and “proton dissociative group” means a functional group capable of desorbing a hydrogen atom as a proton (a hydrogen ion H+) therefrom by ionization. In this description, “carbon cluster” and “proton dissociative group” are similarly defined.

Proton dissociative molecules formed by introducing the proton dissociative group into the carbon cluster such as fullerene exhibits hydrogen-ion conductivity in an aggregate state. It is because it is considered that a large number of proton dissociative groups are included in one fullerene molecule, and the number of proton dissociative groups included per unit volume is extremely large.

After that, various fullerene derivatives such as fullerene-based polymer in which fullerenes are bonded together with an organic group in between are synthesized, and among them, there are reported fullerene derivatives which have higher chemical and thermal stability and are more suitable as the material of the hydrogen-ion-conducting electrolyte membrane, compared to a fullerene derivative exemplified in PTL 1 (for example, refer to Japanese Unexamined Patent Application Publication Nos. 2003-123793, 2003-187636, 2003-303513, 2004-55562, and 2005-68124).

However, the hydrogen-ion-conducting electrolyte membrane 21 used for the fuel cell 20 or the like is supposed to satisfy a wide variety of performance, and in addition to high hydrogen-ion conductivity, high mechanical strength and moderate flexibility, sufficient performance of inhibiting the permeation (cross leak) of a fuel or oxygen, superiority in water resistance, chemical stability or heat resistance, and the like are demanded. There is no presently easily available hydrogen-ion-conducting material solely satisfying all of these demands. For example, most of fullerene-based hydrogen-ion-conducting materials are in a powder form, and may be lower in membrane formability, mechanical strength and flexibility of a membrane, performance of inhibiting the permeation of a fuel or oxygen than polymer materials with superior membrane formability.

Therefore, in PTL 1, or PTL 2 which will be described later proposes a structure in which a composite of a carbon cluster derivative including a proton dissociative group with a polymer material with superior membrane formability is formed to improve membrane formability, mechanical strength and flexibility of a membrane, and performance of inhibiting the permeation of the fuel or oxygen.

In PTL 1, as the polymer material with superior membrane formability, polyfluoroethylene such as polytetrafluoroethylene (PTFE), polyvinylidene fluoride (PVDF), and polyvinyl alcohol (PVA) are exemplified.

PTL 2 proposes a proton-conducting composite which is formed by mixing a carbon cluster derivative including a proton dissociative group and a polymer material having resistance to permeation of water and/or liquid molecules such as alcohol molecules, and includes the polymer material within a mixing ratio range of larger than 15 mass % to 95 mass % inclusive, more preferably within a mixing ratio range of 20 mass % to 90 mass % both inclusive. At this time, the polymer material preferably includes at least a homopolymer or a copolymer of vinylidene fluoride, and the compolymer is preferably a copolymer of hexafluoropropene.

The following description is given in PTL 2. With the above-described structure, as in the case of the above-described polymer material, while maintaining high proton conductivity that the carbon cluster derivative has, a proton-conducting composite with high membrane formability, high mechanical strength or chemical stability of the membrane, and high performance of inhibiting the permeation of water and liquid molecules such as methanol is achievable. At this time, the carbon cluster derivative provides a hydrogen-ion conduction pathway having high proton conductivity. On the other hand, the above-described polymer material has a function of stopping transfer of water and liquid molecules such as methanol, as well as preventing swelling of the carbon cluster derivative by high membrane formability and high mechanical strength.

Moreover, PTL 3 which will be described later proposes sulfonic acid group-introduced amorphous carbon as a hydrogen-ion-conducting material with high proton conductivity, high heat resistance and low manufacturing cost. This material is allowed to be manufactured by heating an organic compound in concentrated sulfuric acid or fuming sulfuric acid. At this time, carbonization, sulfonation, and condensation of rings occur to form sulfonic acid group-introduced amorphous carbon. As an organic compound which is a material, aromatic hydrocarbons are allowed to be used, and a natural product such as sugar, or a synthetic polymer compound may be used, or a material which is not a purified organic compound, for example, heavy oil, pitch, tar, or asphalt including aromatic hydrocarbons, or the like may be used.

Since the above-described solid acid is also in a powder form, to form a membrane, it is necessary to form a composite with a polymer material with high membrane formability. It is described in PTL 3 that when a fluorine-containing monomer such as tetrafluoroethylene, chlorotrifluoroethylene, vinylfluoride, vinylidene fluoride, hexafluoropropene, or perfluoroalkylvinylether, or a copolymer thereof is used as a binder polymer, stability of an electrolyte membrane is remarkably improved.

### CITATION LIST

### Patent Literature

[PTL 1] WO01/06519 (Claims 1, 4, 5, 16, and 18, P. 3, 6-11, 13, and 14, FIGS. 1-57 and 7)
[PTL 2] Japanese Unexamined Patent Application Publication No. 2005-93417 (P. 8 and 12-14, FIGS. 1-4, 6, and 7)
[PTL 3] Japanese Unexamined Patent Application Publication No. 2006-257234 (P. 3 and 5-8, FIG. 1)

### DISCLOSURE OF THE INVENTION

As described above, when an ion-conducting microparticle including an ion-dissociative group such as a carbon cluster derivative or sulfonic acid group-introduced amorphous carbon and a fluorine-containing resin such as PVDF or a copolymer thereof are combined to form a composite, a composite having ionic conductivity as well as high membrane formability, and high mechanical strength and chemical stability of a membrane is achievable. In particular, the fluorine-containing resin is superior in performance of inhibiting the permeation of water, methanol, or the like; therefore, when a hydrogen-ion-conducting electrolyte membrane is formed with use of the composite, a preferred fuel cell as a direct methanol fuel cell (DMFC) is allowed to be formed.

At this time, since the above-described fluorine-containing resin does not have ionic conductivity, to improve ionic conductivity of the composite, it is necessary to include as large an ion-conducting microparticle content as possible. However, the fluorine-containing resin exhibits extremely high water repellency, and does not have an affinity for the highly hydrophilic ion-dissociative group included in the ion-conducting microparticle. Therefore, the ion-conducting microparticle content capable of being uniformly mixed with the fluorine-containing resin has an upper limit. When the content exceeds the upper limit, phase separation between the ion-conducting microparticles and the fluorine-containing resin easily occurs, and the ion-conducting microparticles are not uniformly dispersed in the composite, thereby causing a decline in ionic conductivity, and in the case where the composite is applied to the fuel cell or the like, the composite causes a decline in characteristics of the fuel cell or the like.

The present invention is made to solve the above-described issues, and it is an object of the invention to provide an ion-conducting microparticle including an ion-dissociative group and exhibiting an affinity for a fluorine-containing resin, and a method of manufacturing the same, an ion-conducting composite including the ion-conducting microparticle, a membrane electrode assembly (MEA) including the ion-conducting composite as an electrolyte, and an electrochemical device such as a fuel cell.

The present invention relates to an ion-conducting microparticle including, on a surface of a base-material microparticle:

an ion-dissociative group; and

a reformed group bonded at only one end to the surface of the base-material microparticle, not including, in the other end, an ion-dissociative group, and including, in a main part and/or the other end, an atom group having an affinity for a fluorine-containing resin.

Moreover, the invention relates to a method of manufacturing an ion-conducting microparticle including:

allowing a reacting molecule to act on a material microparticle including an ion-dissociative group and a first reacting group on a surface of a base-material microparticle, the reacting molecule including, in only one end, a second reacting group capable of being bonded to the first reacting group, not including an ion-dissociative group in the other end, and including, in a main part and/or the other end, an atom group having an affinity for a fluorine-containing resin; and introducing a reformed group into the material microparticle by a reaction between the first reacting group and the second reacting group, the reformed group bonded at only one end to the surface of the base-material microparticle, not including, in the other end, an ion-dissociative group, and including, in a main part and/or the other end, an atom group having an affinity for a fluorine-containing resin.

Further, the invention relates to an ion-conducting composite including:

an ion-conducting microparticle; and

a fluorine-containing resin.

Moreover, the invention relates to a membrane electrode assembly including: an ion-conducting composite as an electrolyte sandwiched between facing electrodes, and an electrochemical device including: an electrochemical reaction section formed by sandwiching an ion-conducting composite as an electrolyte between facing electrodes.

The ion-conducting microparticle of the invention includes, on the surface of the base-material microparticle, the reformed group including the atom group having an affinity for the fluorine-containing resin, in addition to the ion-dissociative group; therefore, an affinity for the fluorine-containing resin and dispersibility in the fluorine-containing region are enhanced. At this time, the reformed group are bonded at only one end to the surface of the base-material microparticle, and does not include an ion-dissociative group in the other end; therefore, the atom group occupying the main part and/or the other end of the reformed group and having an affinity for the fluorine-containing resin is allowed to easily come into contact with the fluorine-containing resin. Therefore, the atom group having an affinity for the fluorine-containing resin effectively functions, and the affinity of the ion-conducting microparticle for the fluorine-containing resin is allowed to be enhanced by introducing a relatively small amount of the reformed group.

As a result, in the ion-conducting composite formed of the ion-conducting microparticle and the fluorine-containing resin, the upper limit of the ion-conducting microparticle content capable of being uniformly mixed with the fluorine-containing resin is raised, and as a result, the density of the ion-dissociative group in the ion-conducting composite is allowed to be increased, thereby allowing ion conductivity of the ion-conducting composite to be improved.

Moreover, according to the method of manufacturing an ion-conducting microparticle,

the reacting molecule, which includes, in only one end, the second reacting group capable of being bonded to the first reacting group, does not include the ion-dissociative group in the other end, and include, in the main part and/or the other end, the atom group having an affinity for the fluorine-containing resin, acts on the material microparticle including the ion-dissociative group and the first reacting group on the surface of the base-material microparticle; and introducing the reformed group, which is group bonded at only one end to the surface of the base-material microparticle, does not include, in the other end, the ion-dissociative group, and includes, in the main part and/or the other end, the atom group having an affinity for the fluorine-containing resin, into the material microparticle by the reaction between the first reacting group and the second reacting group;

therefore, the ion-conducting microparticle of the invention is allowed to be easily and reliably manufactured with use of, as a material, a microparticle used as an ion-conducting microparticle in related art.

Further, the ion-conducting composite of the invention includes the ion-conducting microparticle of the invention and the fluorine-containing resin; therefore, by taking advantage of the raised upper limit of the ion-conducting microparticle content capable of being uniformly mixed with the fluorine-containing resin, the ion-conducting microparticle content in the ion-conducting composite, and by extension to the density of the ion-dissociative group are allowed to be increased, thereby allowing ion conductivity of the ion-conducting composite to be improved.

The membrane electrode assembly (MEA) and the electrochemical device of the invention include the ion-conducting composite of the invention as an electrolyte; therefore, electrochemical characteristics thereof are improved.

### BRIEF DESCRIPTION OF THE DRAWINGS

FIG. 1 is a schematic view (a) illustrating a structure of a surface of an ion-conducting microparticle according to an embodiment 1 of the invention, and a schematic view (b) illustrating a process of forming the ion-conducting microparticle.

FIG. 2 is an explanatory diagram illustrating a reaction process when the ion-conducting microparticle is formed with use of a silane coupling agent according to the embodiment 1 of the invention.

FIG. 3 is an explanatory diagram illustrating examples of silane coupling agents including a perfluoroalkyl group as a partial structure in a basic skeleton according to the embodiment 1 of the invention.

FIG. 4 is an explanatory diagram illustrating examples of carboxylic acid and alcohol including a fluoro group in a basic skeleton according to the embodiment 1 of the invention.

FIG. 5 is FT-IR (Fourier transform infrared) absorption spectra of a sample before being subjected to a process of introducing a fluoroalkyl group and a product of the process of introducing the fluoroalkyl group.

FIG. 6 is observed images, taken by a digital camera, illustrating membrane formation states of hydrogen-ion-conducting composite membranes obtained in Example 1 and Comparative Example 1.

FIG. 7 is a graph illustrating results of a power generation test on fuel cells obtained in Example 1 and Comparative Example 1.

FIG. 8 is a sectional view illustrating an example of a configuration of a fuel cell configured as a PEFC.

### BEST MODE(S) FOR CARRYING OUT THE INVENTION

In an ion-conducting microparticle of the invention, an atom group having an affinity for a fluorine-containing resin may be a fluorine-containing organic group. At this time, the fluorine-containing organic group may include a perfluoroalkyl group.

Moreover, a base-material microparticle may be a carbon cluster, an amorphous carbon microparticle, or a silica microparticle.

Further, the carbon cluster may include at least one kind selected from the group consisting of spherical carbon cluster molecules Cₙ (n=36, 60, 70, 76, 78, 80, 82, 84, and the like, commonly called fullerenes).

An ion-dissociative group may include any one of a proton H⁺, a lithium ion Li⁺, a sodium ion Na⁺, a potassium ion K⁺, a magnesium ion Mg²⁺, a calcium ion Ca²⁺, a strontium ion Sr²⁺, and a barium ion Ba²⁺.

The ion-dissociative group may be a hydrogen-ion-dissociative group, and may have hydrogen-ion conductivity. At this time, the hydrogen-ion-dissociative group may include one or more kinds selected from the group consisting of a hydroxy group —OH, a sulfonic acid group —SO₃H, a carboxyl group —COOH, a phosphono group —PO(OH)₂, a dihydrogen phosphate ester group —O—PO(OH)₂, a phosphono methano group >CH(PO(OH)₂), a diphosphono methano group >C(PO(OH)₂)₂, a phosphono methyl group —CH₂(PO(OH)₂), a diphosphono methyl group —CH(PO(OH)₂)₂, and phosphine group —PHO(OH), —PO(OH)—, and —O—PO(OH)—. Hereinafter, a methano group >CH₂ is an atom group forming a bridged structure by bonding two bonding hands of a carbon atom in a methano group to two carbon atoms of a carbon cluster to form a single bond.

In a method of manufacturing an ion-conducting microparticle of the invention, a reaction may be performed by a reaction using a silane coupling agent as a reacting molecule, an esterification reaction of a carboxyl group, or a reaction using chlorosulfonyl compound as a reacting molecule.

In an ion-conducting composite of the invention, a fluorine-containing resin may be a homopolymer or copolymer of vinylidene fluoride, tetrafluoroethylene, or hexafluoropropene. At this time, the copolymer of vinylidene fluoride may be a copolymer with hexafluoropropene. A polyvinylidene fluoride (PVDF)-based resin, specifically, the copolymer of hexafluoropropene has high membrane formability and high performance of inhibiting the permeation of methanol.

An electrochemical device of the invention may be configured as a fuel cell.

Next, preferred embodiments of the invention will be described in detail below referring to the accompanying drawings.

### Embodiment 1

In an embodiment 1, examples of an ion-conducting microparticle and a method of manufacturing the same described in claims 1 to 10, and an ion-conducting composite described in claims 11 to 13 will be mainly described.

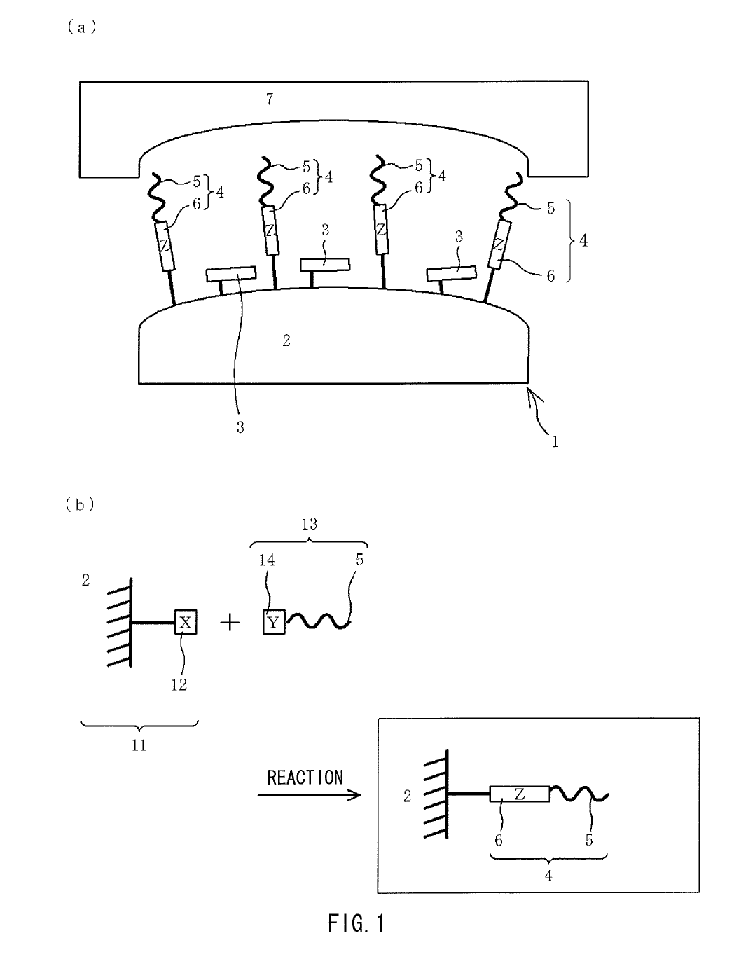

FIG. 1(a) is a conceptual diagram illustrating a structure of a surface of an ion-conducting microparticle 1 having an enhanced affinity for a fluorine-containing resin 7 according to the embodiment 1. The ion-conducting microparticle 1 includes a base-material microparticle 2, an ion-dissociative group 3 present on a surface thereof, and a reformed group 4 which is bonded at only one end to the surface of the base-material microparticle 2, and includes, in a main part and/or the other end, an atom group 5 having an affinity for a fluorine-containing resin.

An ion-conducting microparticle in related art does not include the reformed group 4. In this case, as described above, since the fluorine-containing resin exhibits extremely high water repellency, the fluorine-containing region does not have an affinity for the highly hydrophilic ion-dissociative group 2 included in the ion-conducting microparticle. Therefore, the ion-conducting microparticle content capable of being uniformly mixed with the fluorine-containing resin has an upper limit. When the content exceeds the upper limit, phase separation between the ion-conducting microparticles and the fluorine-containing resin easily occurs, and the ion-conducting microparticles are not uniformly dispersed in a composite, thereby causing a decline in ion conductivity, and in the case where the composite is applied to the fuel cell or the like, the composite causes a decline in characteristics of the fuel cell or the like.

On the other hand, since the ion-conducting microparticle 1 according to the embodiment also includes the reformed group 4 including the atom group 5 having an affinity for the fluorine-containing resin 7, the affinity for the fluorine-containing resin 7 and dispersibility in the fluorine-containing resin 7 are enhanced. At this time, since the reformed group 4 is bonded at only one end to the surface of the base-material microparticle 2, the atom group 5 occupying the main part and/or the other end of the reformed group 4 is allowed to easily come into contact with the fluorine-containing resin 7. Therefore, the atom group 5 having an affinity for the fluorine-containing resin 7 effectively functions, and the affinity of the ion-conducting microparticle 1 for the fluorine-containing resin 7 is allowed to be remarkably enhanced by introducing a relatively small amount of the reformed group 4.

As a result, in the ion-conducting composite formed of the ion-conducting microparticle 1 and the fluorine-containing resin 7, the upper limit of the ion-conducting microparticle content capable of being uniformly mixed with the fluorine-containing resin 7 is raised, and as a result, the density of the ion-dissociative group 2 in the ion-conducting composite is allowed to be increased, thereby allowing ion conductivity of the ion-conducting composite to be improved.

In this case, the atom group 5 having an affinity for the fluorine-containing resin is a fluorine-containing organic group, and more preferably, the fluorine-containing organic group includes a perfluoroalkyl group. In this structure, the atom group 5 exhibits a highest affinity for the fluorine-containing resin 7.

FIG. 1(b) is a schematic view illustrating a process of forming the ion-conducting microparticle 1 according to the embodiment 1. As illustrated in FIG. 1(b), a material microparticle 11 into which the group 4 is not yet introduced includes a first reacting group X12 on the surface of the base-material microparticle 2 in addition to the ion-dissociative group 3 (not illustrated in FIG. 1(b)). On the other hand, a reacting molecule 13 acting on the first reacting group X12 includes, only in one end, a second reacting group Y14 capable of being bonded to the first reacting group X12, and includes, in a main part and/or the other end, the atom group 5 having an affinity for the fluorine-containing resin 7. When the reacting molecule 13 acts on the material microparticle 11 under an appropriate condition, a reaction occurs between the first reacting group X12 and the second reacting group Y14 to form a linking group Z6. As a result, the atom group 5 having an affinity for the fluorine-containing resin is introduced into the surface of the base-material microparticle 2 through the linking group Z6.

The reaction to form the linking group Z6 from the first reacting group X12 and the second reacting group Y14 is not specifically limited, and may include a dehydration-condensation reaction between hydroxy groups, an esterification reaction, and the like. X may be a hydroxy group, a carboxyl group, a sulfonic acid group, or an epoxy group. Three different reactions to form the linking group Z6 will be described below.

(1. Case Where Silane Coupling Agent as Reacting Molecule is Used)

In the case where the ion-conducting microparticle 1 is formed with use of an silane coupling agent, first, the silane coupling agent as the reacting molecule 13 is dropped little by little into a suspension prepared by dispersing the material microparticles 1 in an organic solvent such as anhydrous toluene, and then adding a small amount of pure water into the organic solvent, and the suspension is stirred at room temperature for 1 to 3 days. After a reaction is completed, a precipitate is cleaned with an organic solvent such as toluene, and is recovered by filtration or centrifugal separation. The obtained precipitate is vacuum-dried to obtain the ion-conducting microparticles 1 in a powder form.

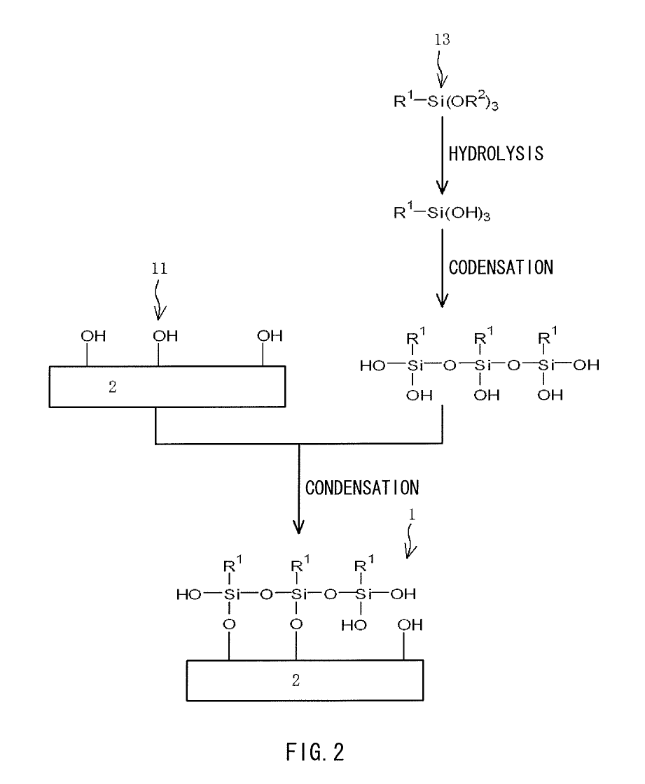

FIG. 2 is an explanatory diagram illustrating a reaction process when the ion-conducting microparticle 1 is formed with use of a silane coupling agent. First, a silane coupling agent R¹Si(OR²)₃ is converted into organic trisilanol Si(OH)₃ by hydrolysis. Some of organic trisilanols R¹Si(OH)₃ are condensed with one another to be converted into an oligomer. Next, a monomer or an oligomer of organic trisilanol is condensed by a dehydration-condensation reaction between a hydroxy group, an —OH group present on the surface of the base-material microparticle 2 and a hydroxy group. As a result, an —O—Si— bond is formed as the linking group 6, and a basic skeleton —R1 is linked to the surface of the base-material microparticle 2 through the linking group 6.

The general formula of the silane coupling agent is illustrated below. General formula of silane coupling agent:

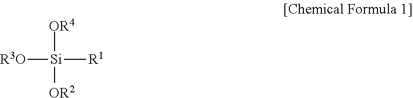

FIG. 2 illustrates the silane coupling agent in the case of R²═R³═R⁴ in the above-described general formula. In the case where a group —R¹ as a basic skeleton is an organic group including a fluorine atom, the organic group including the fluorine atom is allowed to be introduced as the atom group 5 having an affinity for the fluorine-containing resin 7 into the surface of the base-material microparticle 2. In Example 1 which will be described later, 2-(tridecafluorohexy Dethyltriethoxy silane represented by the following structural formula was used. In this case, —R¹ is —CH₂CH₂C₆F₁₃, and —R² is —CH₂CH₃.

Structural formula of 2-(tridecafluorohexypethyltriethoxysilane:

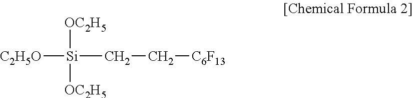

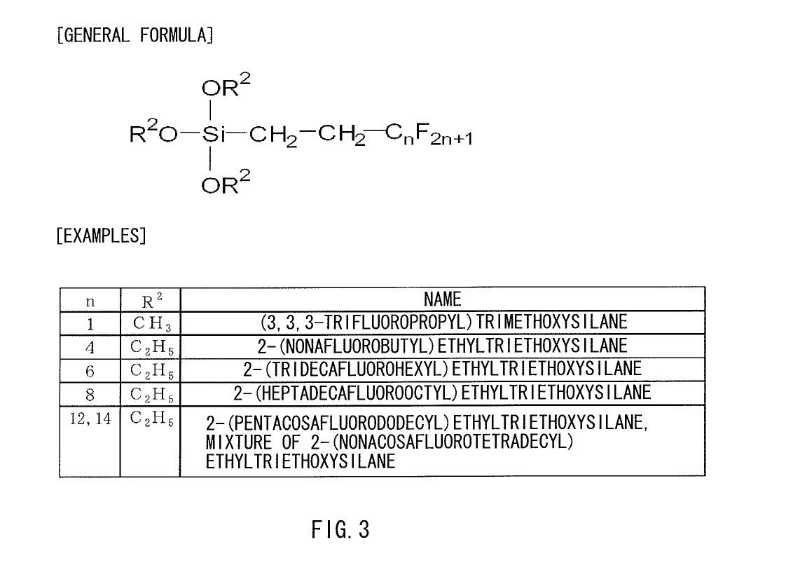

FIG. 3 illustrates examples of silane coupling agents which are easily available as commercially available reagents and include a perfluoroalkyl group as a partial structure of the group —R¹ as the basic skeleton. Even if these silane coupling agents are used, the group —R¹ is allowed to be introduced into the surface of the material microparticle 11 by the reaction process illustrated in FIG. 2, and the same effects as those in Example 1 are allowed to be expected. Moreover, in addition to the exemplified silane coupling agents, a silane coupling agent including a fluoro group in a basic skeleton is allowed to be used without difficulty.

FIG. 2 illustrates an example in which the first reacting group X12 included in the material microparticle 11 is a hydroxy group —OH; however, when a —OH group in a broad sense is included, the —OH group is allowed to react with the silane coupling agent. Therefore, The first reacting group X12 may be a carboxyl group —COOH, or a sulfonic acid group —SO₃H. Moreover, an example in which the second reacting group Y14 included in the silane coupling agent is an —OR² group is illustrated; however, even if the second reacting group Y14 is an —OH group, or a halogen group (such as —Cl) producing an —OH group by hydrolysis, the same reaction occurs.

(2. Case Where Esterification Reaction of Carboxyl Group is Used)

In the case where a hydroxy group —OH is present on the surface of the material microparticle 11, the reacting molecule 13 including a carboxyl group —COOH acts on the material microparticle 11. For example, appropriate amounts of the material microparticle 11 and the reacting molecule 13 are dispersed in an organic solvent such as toluene. After dicyclohexylcarbodiimide equivalent to approximately twice as large as the amount of reacting molecule 13 and dimethylaminopyridine equivalent to approximately 0.2 times as large as the amount of reacting molecule 13 are added to a resultant dispersion liquid, the dispersion liquid is stirred at room temperature for one day. After a reaction is completed, a precipitate is cleaned with toluene and methanol, and is recovered by filtration or centrifugal separation. The obtained precipitate is vacuum-dried to obtain the ion-conducting microparticle 1 in a powder form.

In the case where the carboxyl group —COOH is present on the surface of the material microparticle 11, the reacting molecule 13 including the hydroxy group —OH acts on the material microparticle 11. The ion-conducting microparticle 1 is obtained by the same manner as the above-described manner, except for this.

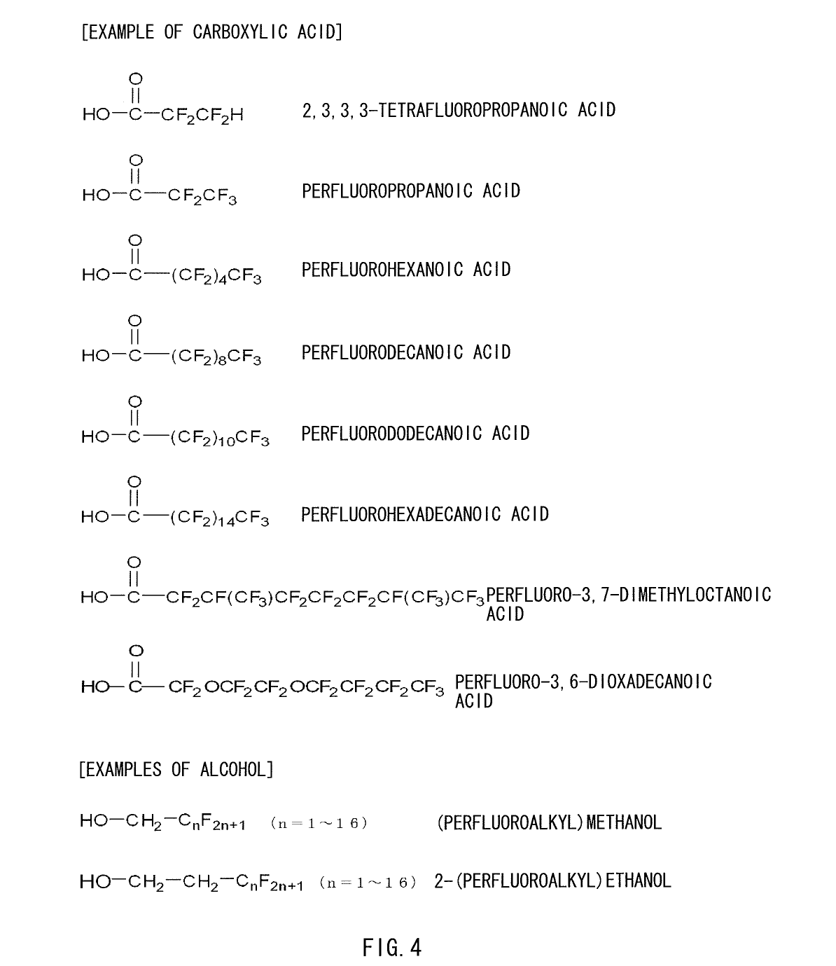

FIG. 4 illustrates examples of carboxylic acid and alcohol which are easily available as commercially available reagents and include a fluoro group in a basic skeleton. Moreover, in addition to the exemplified carboxylic acid and alcohol, carboxylic acid and alcohol including a fluoro group in a basic skeleton are allowed to be used without difficulty.

(3.Case Where Chlorosulfonyl Compound is Used as Reacting Molecule)

In the case where the hydroxy group —OH is present on the surface of the material microparticle 11, a sulfonic acid ester bond is allowed to be formed as the linking group Z6 with use of, as the reacting molecule 13, a sulfonyl compound including a chlorosulfonyl group —SO₂Cl as the second reacting group Y14.

In this case, the material microparticles 11 are dispersed into a solvent such as tetrahydrofuran (THF), and triethylamine is added to a resultant dispersion liquid, and the dispersion liquid is stirred for 2 hours. On the other hand, the sulfonyl compound is dissolved in a small amount of THF. While the dispersion liquid including the material microparticles 11 is cooled with ice, a solution including the sulfonyl compound is dropped into the dispersion liquid little by little. After dropping is completed, a resultant reactive solution is stirred at room temperature for one day. After a reaction is completed, a precipitate is cleaned with THF and methanol, and is recovered by filtration or centrifugal separation. The obtained precipitate is vacuum-dried to obtain the ion-conducting microparticle 1 in a powder form.

Examples of sulfonyl compounds which are easily available as commercially available reagents, and include a fluoro group in a basic skeleton are illustrated below, In addition to exemplified sulfonyl compounds, a chlorosulfonyl compound including a fluoro group in a basic skeleton is allowed to be used without difficulty.

Structural formula of perfluorooctane sulfonyl chloride:

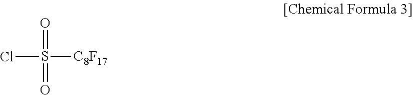

(Material Microparticle)

The material microparticle 11 is a particle with a size capable of forming a surface structure, for example, with an outside diameter of several nanometers to several micrometers. In the case where the material microparticle 11 includes the ion-dissociative group 3 on a surface thereof, and has hydrogen-ion dissociation, the material microparticle 11 includes an acidic group such as a sulfonic acid group, a phosphono group, or a carboxyl group. Moreover, to introduce the reformed group 4, the first reacting group 12 is necessary. Examples of the first reacting group 12 include a hydroxy group —OH, a carboxyl group —COOH, and a sulfonic acid group —SO₃H. In the case where the ion-dissociative group 3 is a sulfonic acid group or a carboxyl group, a part thereof may be used as the first reacting group 12. Further, the material microparticle 11 is insoluble in water, and as the base-material microparticle 2, a material having an electron transfer property, for example, a conductive carbon material is not used.

A material satisfying such conditions is allowed to be found from materials used as ion-conducting microparticles in related art, and, for example, a carbon cluster or amorphous carbon into which a sulfonic acid group is introduced is applicable. In addition to them, a porous body of silica into which a sulfonic acid group is introduced (refer to Chem. Rev., 2006, 106, 3790-3812) or an inorganic polyacid such as tungstophosphoric acid is allowed to be used (refer to Solid State Ionics, 2007, 178, 527-531 for an example of a proton-conducting membrane in which tungstophosphoric acid and PVDF are mixed). Moreover, as an organic polymer, polystyrene sulfonate, a compound formed by introducing a sulfonic acid group into polyimide, or a crosslink, a copolymer thereof, or the like may be used (refer to Chem. Rev., 2004, 104, 4587-4612 for an example of the proton-conducting polymer). Further, in the case where a material used as the ion-conducting microparticle does not include the first reacting group 12, the material is allowed to be used as the material microparticle 11 by adding a process of introducing the first reacting group 12.

For example, a carbon cluster derivative including an ion-dissociative group is appropriately selected from fullerene derivatives and the like exemplified in PTLs 1 and 2 and Japanese Unexamined Patent Application Publication Nos. 2003-123793, 2003-187636, 2003-303513, 2004-55562 and 2005-68124, and the like based on use conditions in consideration of ionic conductivity or chemical and thermal stability. Fullerenes are spherical carbon cluster molecules Cn (n=36, 60, 70, 76, 78, 80, 82, 84, and the like), and in particular, C₆₀ and/or C₇₀ are preferable. In a currently used method of manufacturing a fullerene, the formation rates of C₆₀ and C₇₀ are predominantly high, and in terms of manufacturing cost, a merit of using C₆₀ and/or C₇₀ is large. However, the carbon cluster derivative is not limited to a fullerene derivative, and may be derivatives of other carbon nanoparticles such as carbon nanohorn. Moreover, a carbon material such as inexpensive petroleum pitch into which an acidic group such as sulfonic acid group is introduced may be used.

The ion-dissociative group is not specifically limited; however, the ion-dissociative group preferably includes any one of a proton H⁺, a lithium ion Li⁺, a sodium ion Na⁺, a potassium ion K⁺, a magnesium ion Mg²⁺, a calcium ion Ca²⁺, a strontium ion Sr²⁺, and a barium ion Ba²⁺.

In particular, the ion-dissociative group is preferably a hydrogen-ion-dissociative group, and the carbon cluster derivative preferably has hydrogen-ion conductivity. At this time, the hydrogen-ion-dissociative group may include one or more kinds selected from the group consisting of a hydroxy group —OH, a sulfonic acid group —SO₃H, a carboxyl group —COOH, a phosphono group —PO(OH)₂, a dihydrogen phosphate ester group —O—PO(OH)₂, a phosphono methano group >CH(PO(OH)2), a diphosphono methano group >C(PO(OH)₂)₂, a phosphono methyl group —CH₂(PO(OH)₂), a diphosphono methyl group —CH(PO(OH)₂)₂, and phosphine groups —PHO(OH), —PO(OH)—, and —O—PO(OH)—.

It is to be noted that in the case where, in a system in which the ion-dissociative group 3 such as a sulfonic acid group and the second reacting group 14 react with each other, a group capable of reacting with the second reacting group 14 except for the ion-dissociative group 3 is not present in the material microparticle 11, the amount Wf (mmol/g) of the reformed group 4 to be introduced per gram of the material microparticle 11 is necessary to satisfy the following condition, where the content (density) of the ion-dissociative group 3 in the material microparticle 11 is Ws (mmol/g).

0<Wf<Ws (Formula 1)

This condition is established to allow the ion-dissociative group 3 to remain in the ion-conducting microparticle 1 after a reaction, thereby not losing ionic conductivity.

At this time, in the case where a difference in mass between the material microparticle 11 and the ion-conducting microparticle 1 is negligible, the content (density) P of the ion-dissociative group 3 in the ion-conducting microparticle 1 is determined by the following (Formula 2).

P=Ws−Wf (Formula 2)

Moreover, in the case where the mass ratio of the ion-conducting microparticle 1 to the fluorine-containing resin in the ion-conducting composite is 1:R, the content (density) Q of the ion-dissociative group 3 in an ion-conducting composite membrane is determined by the following (Formula 3).

Q=(Ws−Wf)/(1+R) (Formula 3)

As performance of the ion-conducting composite as an electrolyte, the content (density) Q is desirably larger than approximately 0.9 mmol/g equivalent to typical ion exchange capacity of Nafion (a registered trademark). It is found out that in an ion-conducting composite obtained in Example 1 which will be described later, the content (density) Q is determined to be equal to or larger than 2.24 mmol/g, and an electrolyte membrane with extremely large ion exchange capacity is obtained.

### Embodiment 2

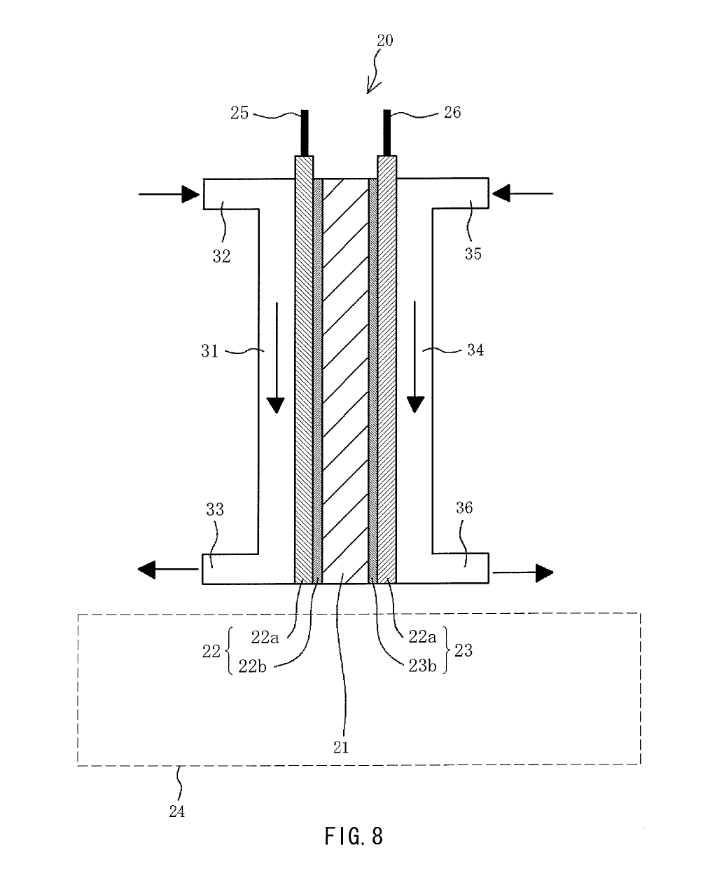

In an embodiment 2, examples of an ion-conducting composite described in claims 11 to 13 and a membrane electrode assembly (MEA) described in claims 9 to 11, and an example in which the hydrogen-ion-conducting microparticle formed in the embodiment 1 is applied to a fuel cell 20 described as an example of an electrochemical device referring to FIG. 8 will be mainly described.

(Formation of Ion-Conducting Composite)

To form the ion-conducting composite, first, a carbon cluster derivative including an ion-dissociative group is added to an appropriate organic solvent, and the solvent is stirred to uniformly disperse the carbon cluster derivative in the solvent. Next, powder of polyvinylidene fluoride (PVDF) or a copolymer thereof is added to a resultant dispersion liquid, and the dispersion liquid is stirred to prepare a coating fluid. Next, the coating fluid prepared in such a manner is uniformly applied to and spread on a base material to form a coating. The solvent is gradually evaporated from this coating to form the ion-conducting composite in a membrane form. The thickness of the ion-conducting composite membrane is controllable by the amount of the applied coating fluid.

The fluorine-containing resin may be a homopolymer or copolymer of vinylidene fluoride, tetrafluoroethylene, or hexafluoropropene. At this time, the copolymer of vinylidene fluoride may be a copolymer of hexafluoropropene. A polyvinylidene fluoride (PVDF)-based resin, specifically, the copolymer of hexafluoropropene has high membrane formability and high performance of inhibiting the permeation of methanol.

As the above-described organic solvent, cyclopentanone, acetone, propylene carbonate, γ-butyrolactone, and the like are allowed to be used. Moreover, as the base material, a glass plate, or a film or a sheet made of an organic polymer resin such as polyimide, polyethylene terephthalate (PET), or polypropylene (PP) is allowed to be used.

(Formation of Membrane Electrode Assembly (MEA))

The hydrogen-ion-conducting composite membrane formed in the above-described manner is cut into an appropriate planar shape. The hydrogen-ion-conducting composite membrane is sandwiched between an anode 22 and a cathode 23, and is subjected to, for example, thermocompression bonding for 15 minutes at a temperature of 130° C. and a pressure of 0.5 kN/cm² to form a membrane electrode assembly 24.

As described above referring to FIG. 8, the membrane electrode assembly (MEA) 24 is sandwiched between a fuel channel 31 and an oxygen (air) channel 34, and is mounted in the fuel cell 20. During power generation, in the anode 22, a fuel such as hydrogen is supplied from a fuel inlet 32, and is discharged from a fuel outlet 33. In the meantime, a part of the fuel passes through a gas-permeable current collector (gas diffusion layer) 22a to reach an anode catalyst layer 22b. As the fuel of the fuel cell, various combustible materials such as hydrogen and methanol may be used. In the cathode 23, oxygen or air is supplied from an oxygen (air) inlet 35, and is discharged from an oxygen (air) outlet 36. In the meantime, a part of oxygen (air) passes through a gas-permeable current collector (gas diffusion layer) 23a to reach a cathode catalyst layer 23b.

In the case where the fuel cell is a direct methanol fuel cell (DMFC), methanol as a fuel is supplied in a form of a methanol solution or pure methanol, and evaporated methanol molecules reach the anode catalyst layer 22b. The methanol molecules are oxidized on anode catalyst particles by a reaction represented by the following reaction formula (4) to apply electrons to the anode 22.

CH₃OH+H₂O→CO₂−6H^{|}+6e⁻ (4)

The generated hydrogen ions H⁻ are transferred to the cathode 23 through a polymer electrolyte membrane 21. Oxygen supplied to the cathode catalyst layer 23b reacts with hydrogen ions transferred from the anode on cathode catalyst particles by a reaction represented by the following reaction formula (5) to be reduced, and then electrons are taken from the cathode 23.

(3/2)O₂+6H⁺+6e⁻→3H₂O (5)

In the whole fuel cell, a reaction represented by the following reaction formula (6) obtained by combining the reaction formulae (4) and (5) occurs.

CH₃OH|(3/2)O₂→CO₂|2H₂O (6)

### EXAMPLES

In examples, first, a hydrogen-ion-conducting microparticle as the ion-conducting microparticle 1 was formed by a manufacturing method using the silane coupling agent described in the embodiment 1. Next, as described in the embodiment 2, the hydrogen-ion-conducting composite was formed with use of the hydrogen-ion-conducting microparticle and the fluorine-containing resin, and a membrane formation state thereof was observed. Next, the hydrogen-ion-conducting composite membrane was used as an electrolyte to form the membrane electrode assembly 24 and the fuel cell 20 described in the embodiment 2 to determine power generation performance. Needless to say, the invention is not limited to the following examples.

### Example 1

(Material Microparticle (Microparticle Including Hydrogen-Ion-Dissociative Group))

In Example 1, amorphous carbon into which a sulfonic acid group was introduced and which was proposed in PTL 3 was used as the material microparticle 11. The material was obtained with use of pitch (coal tar) as an organic compound material; therefore, the material is hereinafter referred to as sulfonated pitch. A result of elemental analysis of the sulfonated pitch is illustrated in Table 1. Assuming that all sulfur S included in the sulfonated pitch is present as a sulfonic acid group, the content (density) Ws of the sulfonic acid group is estimated to be 4.68 mmol/g.

TABLE 1
Elemental Composition (mass %)

| C | H | N | S |
|---|---|---|---|
| 44.5 | 3.38 | — | 14.97 |

The above-described sulfonated pitch was synthesized by the following manner. First, 10 g of coal tar (manufactured by Wako Pure Chemical Industries, Ltd.) was put into a round-bottomed flask, and air in the flask substitutes for a nitrogen airflow, and then, the flask including the coal tar was put into an ice bath, and the coal tar was gently stirred with a stirring bar. Next, while the flask was sufficiently cooled with ice, 200 mL of 25-mass %-fuming sulfuric acid (manufactured by Wako Pure Chemical Industries, Ltd.) was carefully dropped into the flask little by little not to cause considerable heat generation. After that, while the flask was dipped in the ice bath for a while, the coal tar was continuously vigorously stirred at room temperature to gradually return a liquid temperature to room temperature, and then the coal tar was continuously stirred for another 8 hours.

After that, the flask including the coal tar was put into an ice bath again, and 500 mL of ion exchange water was gradually added while taking care not to increase the liquid temperature too high, thereby causing bumping or the like. A resultant suspension was subjected to a centrifugal separation process to remove a supernatant fluid. After that, the same cleaning operation was performed 5 or more times. After it was confirmed that the supernatant fluid did not include sulfate ions, a resultant precipitate was vacuum-dried at ambient temperatures to obtain 7 g of a slightly brown-tinted black aggregate. The resultant aggregate was pulverized with use of a ball mill (manufactured by Fritsch GmbH), and fine powder having passed through a sieve with a 32-μm mesh was recovered to be used in the next process.

(Process of Introducing Reformed Group 4 Including Fluoroalkyl Group)

The above-described sulfonated pitch was used as the material microparticle 11, and a process of introducing the reformed group 4 including a fluoroalkyl group into the sulfonated pitch was performed. First, the sulfonated pitch was pulverized in a mortar, and was screened with use of a sieve with a 75-μm mesh. One and a half grams of a material having passed through the sieve was dispersed in 20 mL of anhydrous toluene, and 75 μL of pure water was added to anhydrous toluene, and was stirred. Then, 75 μL of 2-(tridecafluorohexyl)ethyltriethoxysilane (manufactured by Tokyo Chemical Industry Co., Ltd.; Product No. T1770) was dropped into a resultant suspension little by little. Even after dropping was completed, the suspension was continuously stirred for 1 to 3 days to complete a reaction.

After that, a solvent was removed from the black suspension by centrifugal separation. Next, after a resultant precipitate was cleaned with 20 mL of toluene, a process of removing the solvent by centrifugal separation was performed three or more times, and the resultant precipitate was vacuum-dried for 6 or more hours.

By the above process, approximately 1.5 g, which was substantially equivalent to the mass of the used material, of sulfonated pitch into which the reformed group 4 including the fluoroalkyl group was introduced was obtained. It is to be noted that in this example, sulfonated pitch having passed through the sieve with a 75-μm mesh was used as the material to improve ease in handing during the reaction or drying. Moreover, the particle diameter thereof was equal to the size of secondary aggregate sulfonated pitch, but not the size of the sulfonated pitch itself

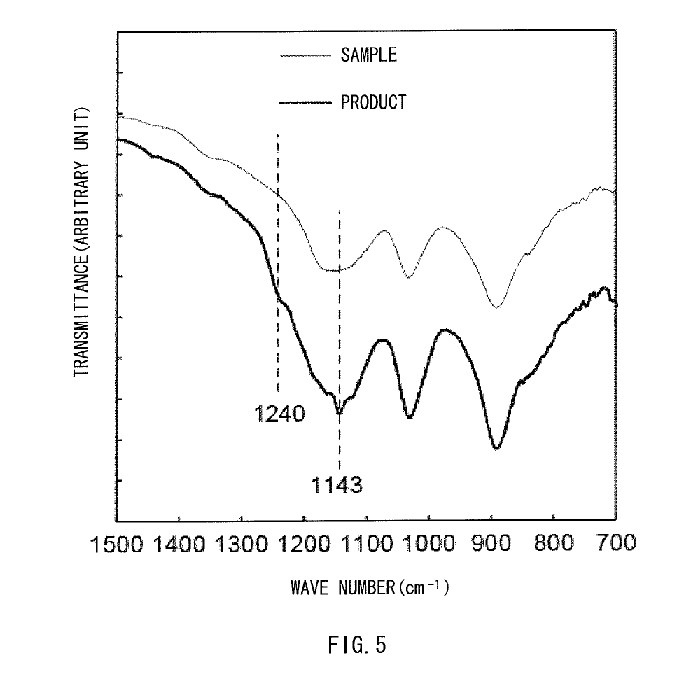

FIG. 5 is FT-IR (Fourier transform infrared) absorption spectra of the material before being subjected to the process of introducing the reformed group 4 including a fluoroalkyl group and a product of the process of introducing the reformed group 4 including the fluoroalkyl group. In the spectrum of the material before being subjected to the introducing process, absorption peaks by the fluoroalkyl group were not observed around 1143 cm⁻¹ and 1240 cm⁻¹. On the other hand, in the spectrum of the sulfonated pitch obtained by the introducing process, absorption peaks by the fluoroalkyl group were observed around 1143 cm⁻¹ and 1240 cm⁻¹. Therefore, it was confirmed that the fluoroalkyl group was introduced into the sulfonated pitch by the above-described process.

(Formation of Hydrogen-Ion-Conducting Composite Membrane)

The sulfonated pitch into which the reformed group 4 including the fluoroalkyl group was introduced was added to γ-butyrolactone (manufactured by Wako Pure Chemical Industries, Ltd., special grade), and was stirred for 2 hours to be uniformly dispersed. PVDF powder was added to a resultant dispersion liquid, and if necessary, a solvent was further added to the dispersion liquid, and while the temperature of the dispersion liquid was kept at 80° C., the dispersion liquid was stirred for 3 or more hours to uniformly disperse the PVDF powder.

Next, a coating fluid prepared in such a manner was uniformly applied to and spread on a polypropylene sheet to form a coating. The solvent was gradually evaporated from the coating in a clean bench to form the ion-conducting composite in a membrane form. Moreover, the obtained thin membrane was left in a dryer kept at 60° C. for 3 hours to evaporate the solvent, thereby drying the thin membrane. The thickness of the dried thin membrane was 15 μm.

The thickness of the ion-conducting composite membrane is controllable by changing the concentration of the applied coating fluid and the amount of the applied coating fluid per unit area. For example, the thickness of the ion-conducting composite membrane was controllable within a range of approximately 3 to 50 μm by keeping the concentration of the coating fluid within a range of 0.01 to 0.030 in mass ratio with respect to the solvent, and changing the thickness of the coating within a range of 30 to 2000 μm according to the concentration.

As Comparative Example 1, a hydrogen-ion-conducting composite membrane was formed as in the case of Example 1, except that instead of the sulfonated pitch into which the reformed group 4 including the fluoroalkyl group was introduced, sulfonated pitch into which the fluoroalkyl group was not introduced was used.

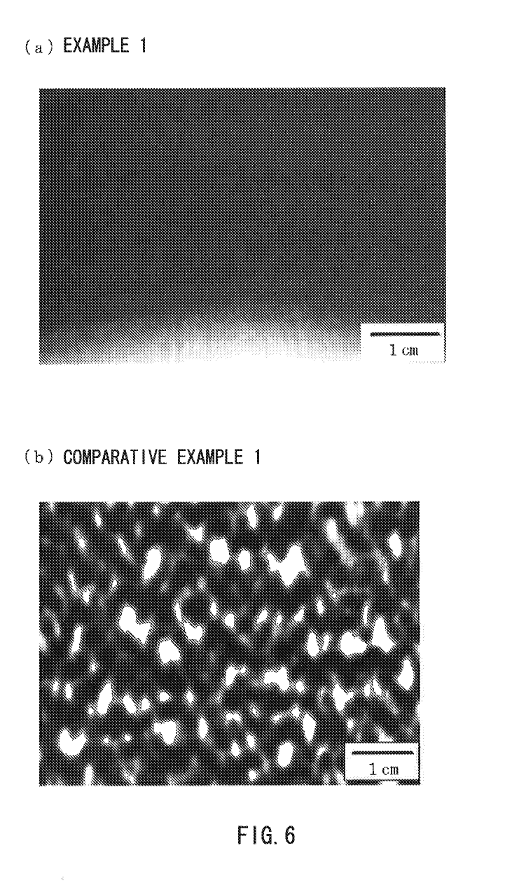

FIG. 6 is observed images, by a digital camera, illustrating membrane formation states of hydrogen ion-conducting composite membranes obtained in Example 1 and Comparative Example 1. In an observed image, illustrated in FIG. 6(b), of the hydrogen-ion-conducting composite membrane obtained in Comparative Example 1, a black part was sulfonated pitch, and a white part was PVDF, and it was obvious that the membrane was not formed uniformly. It was considered that it was because highly hydrophilic sulfonated pitch and PVDF exhibiting high water repellency caused phase separation. On the other hand, in an observed image, illustrated in FIG. 6(a), of the hydrogen-ion-conducting composite membrane obtained in Example 1, compared to Comparative Example 1, uniformity was improved as a whole. It meant that an affinity for PVDF and dispersibility in PVDF were enhanced by introducing the fluoroalkyl group.

Table 2 illustrates results of observation of the membrane formation states by variously changing the mass ratio of sulfonated pitch to PVDF powder. In the table, a circle mark “^{∘}” indicates that the membrane formability was good (no phase separation occurred), a triangle mark “Δ” indicates that the membrane formability was not good (a partial defect such as a nonuniform pattern due to the occurrence of phase separation occurred), and a cross mark “×” indicates that the membrane formability was poor (peeling from a base material during drying after agglomeration, or the like occurred). It was found out from this table that in Example 1, a good membrane formation state was achieved in a wider range of mass ratio than that in Comparative Example 1, and the upper limit of the ion-conducting microparticle content capable of being uniformly mixed with a fluorine-containing resin was raised.

TABLE 2

| Mass Ratio | | |
|---|---|---|
| Sulfonated Pitch:PVDF | Example 1 | Comparative Example 1 |
| 6.5:3.5 | ∘ | x (peeling from base material |
| | | after agglomeration) |
| 6:4 | ∘ | x (peeling from base material |
| | | after agglomeration) |
| 5:5 | ∘ | Δ (phase separation) |
| 4.5:5.5 | ∘ | Δ (nonuniform pattern) |
| 4:6 | ∘ | ∘ |
| 3.5:6.5 | ∘ | ∘ |

The hydrogen-ion-conducting composite membrane formed in the above-described manner may be peeled from the base material and be cut into an appropriate size to be used as an electrolyte film for fuel cell. In the following examples, the hydrogen-ion-conducting composite membrane was formed to have 1:1 as a mass ratio of sulfonated pitch to PVDF power, and a fuel cell test was performed.

Now, the content (density) of the sulfonic acid group in the above-described hydrogen-ion-conducting composite membrane is estimated. Seventy five microliters of 2-(tridecafluorohexyl)ethyltriethoxysilane (with a molecular weight of 510.4 and a density of 1.34 g/mL) is equivalent to 0.197 mmol. Therefore, in a reaction of the above-described silane coupling agent, 0.197 mmol per gram of the sulfonated pitch of the silane coupling agent acts. Assuming that the all amount of the silane coupling agent reacts with the sulfonic acid group, and a difference in mass between sulfonated pitch and sulfonated pitch into which the reformed group 4 is introduced is negligible, the content (density) P of the sulfonic acid group remaining in the ion-conducting microparticle 1 obtained by the reaction is determined as follows by the content (density), 4.68 mmol/g, of the sulfonic acid group in the sulfonated picth, and (Formula 2).

$$\begin{matrix}P = ( 4.68 - 0.197 ) ( mmol / g ) \\ = 4.483 ( mmol / g )\end{matrix}$$

Moreover, assuming that the mass ratio of sulfonated pitch into which the reformed group 4 is introduced to PVDF in the hydrogen-ion-conducting composite is 1:1, the content (density) Q of the sulfonic acid group in the hydrogen-ion-conducting composite membrane is determined as follows by (Formula 3).

Q=4.483/(1−1)(mmol/g)≈2.24(mmol/g)

Actually, a part of the silane coupling agent may not react with the sulfonated pitch, or may react with a hydroxy group or a carboxyl group included in the sulfonated pitch; therefore, the above-described values P and Q are possible minimum values, and actual values P and Q are larger than the minimum values.

(Formation of Membrane Electrode Assembly (MEA) and Fuel Cell)

The above-described hydrogen-ion-conducting composite membrane was cut into a square of 14 mm×14 mm to be used as the electrolyte membrane 21. The electrolyte membrane 21 was sandwiched between the anode 22 and the cathode 23 both having a planar square shape of 10 mm×10 mm, and was subjected to, for example, thermocompression bonding for 15 minutes at a temperature of 130° C. and a pressure of 0.5 kN/cm² to form the membrane electrode assembly 24. As the anode 22 and the cathode 23, gas diffusion electrodes formed by coating a current collector made of carbon paper (product name: TPG-H-090; manufactured by Toray Industries, Inc.) with a coating fluid prepared by mixing catalyst particles and a Nafion (registered trademark) dispersion liquid (product name: DE-1021; E. I. du Pont de Nemours and Company), and then evaporating a solvent to form a catalyst layer were used. As the catalyst particles used in respective electrodes, a supported catalyst in which a platinum catalyst Pt was supported by carbon black (manufactured by Tanaka Kikinzoku Kogyo K. K.; an amount of supported platinum of 70%) and a supported catalyst in which a platinum-ruthenium alloy catalyst PtRu was supported by carbon black (manufactured by E-TEK Inc.; Pt:Ru=2:1) were used.

(Power Generation Test on Fuel Cells)

Pure methanol was supplied as a fuel to the anode 22 of the fuel cell 20, and air was supplied to the cathode 23 by natural aspiration, and a power generation test was performed at a room temperature of 25° C.

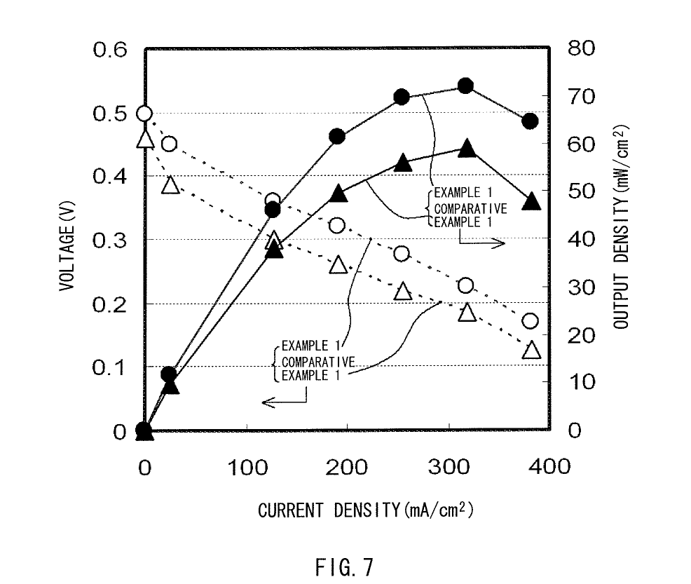

FIG. 7 is a graph illustrating results of the power generation test on fuel cells obtained in Example 1 and Comparative Example 1. It was found out from FIG. 7 that in both of current density-voltage curves and current density-output density curves, compared to the fuel cell obtained in Comparative Example 1, the fuel cell obtained in Example 1 was superior in power generation performance. It is considered that it is because in the case where a membrane is formed with use of sulfonated pitch with a poor affinity for PVDF and poor dispersibility in PVDF as in the case of Comparative Example 1, the sulfonated pitch is nonuniformly dispersed in the membrane; therefore, the sulfonic acid group of the sulfonated pitch is buried, and does not effectively contribute to hydrogen-ion conductivity.

Although the present invention is described referring to the embodiments and examples, the above-described examples may be modified within the technical ideas of the invention without departing from the scope of the invention.

### INDUSTRIAL APPLICABILITY

The ion-conductive composite and a method of manufacturing the same improves manufacturing yields of the ion-conducting electrolyte membrane, and are allowed to contribute to the spreading of electrochemical devices such as fuel cells.

1-16. (canceled)

17. An ion-conducting microparticle comprising, on a surface of a base-material microparticle:
an ion-dissociative group; and
a reformed group bonded at only one end to the surface of the base-material microparticle, not including, in the other end, an ion-dissociative group, and including, in a main part and/or the other end, an atom group having an affinity for a fluorine-containing resin.

18. The ion-conducting microparticle according to claim 17, wherein
the atom group having an affinity for a fluorine-containing resin is a fluorine-containing organic group.

19. The ion-conducting microparticle according to claim 18, wherein
the fluorine-containing organic group includes a perfluoroalkyl group.

20. The ion-conducting microparticle according to claim 17, wherein
the base-material microparticle is a carbon cluster, an amorphous carbon microparticle, or a silica microparticle.

21. The ion-conducting microparticle according to claim 20, wherein
the carbon cluster includes at least one kind selected from the group consisting of spherical carbon cluster molecules Cₙ (n=36, 60, 70, 76, 78, 80, 82, 84, and the like, commonly called fullerenes).

22. The ion-conducting microparticle according to claim 17, wherein
the ion-dissociative group includes any one of a proton H⁺, a lithium ion Li⁺, a sodium ion Na^{|}, a potassium ion K^{|}, a magnesium ion Mg^{2|}, a calcium ion Ca^{2|}, a strontium ion Sr^{2|}, and a barium ion Ba²⁺.

23. The ion-conducting microparticle according to claim 22, wherein
the ion-dissociative group is a hydrogen-ion-dissociative group, and has hydrogen-ion conductivity.

24. The ion-conducting microparticle according to claim 23, wherein
the hydrogen-ion-dissociative group includes one or more kinds selected from the group consisting of a hydroxy group —OH, a sulfonic acid group —SO₃H, a carboxyl group —COOH, a phosphono group —PO(OH)₂, a dihydrogen phosphate ester group —O—PO(OH)₂, a phosphono methano group >CH(PO(OH)₂), a diphosphono methano group >C(PO(OH)₂)₂, a phosphono methyl group —CH₂(PO(OH)₂), a diphosphono methyl group —CH(PO(OH)₂)₂, and phosphine groups —PHO(OH), —PO(OH)—, and —O—PO(OH)—.

25. A method of manufacturing an ion-conducting microparticle comprising:
allowing a reacting molecule to act on a material microparticle including an ion-dissociative group and a first reacting group on a surface of a base-material microparticle, the reacting molecule including, in only one end, a second reacting group capable of being bonded to the first reacting group, not including an ion-dissociative group in the other end, and including, in a main part and/or the other end, an atom group having an affinity for a fluorine-containing resin; and
introducing a reformed group into the material microparticle by a reaction between the first reacting group and the second reacting group, the reformed group bonded at only one end to the surface of the base-material microparticle, not including, in the other end, an ion-dissociative group, and including, in a main part and/or the other end, an atom group having an affinity for a fluorine-containing resin.

26. The method of manufacturing an ion-conducting microparticle according to claim 25, wherein
the reaction is performed by a reaction using a silane coupling agent as the reacting molecule, an esterification reaction of a carboxyl group, or a reaction using a chlorosulfonyl compound as the reacting molecule.

27. An ion-conducting composite comprising:
an ion-conducting microparticle according to claim 17; and
a fluorine-containing resin.

28. The ion-conducting composite according to claim 27, wherein
the fluorine-containing resin is a homopolymer or copolymer of vinylidene fluoride, tetrafluoroethylene, or hexafluoropropene.

29. The ion-conducting composite according to claim 28, wherein
the copolymer of vinylidene fluoride is a copolymer with hexafluoropropene.

30. A membrane electrode assembly comprising:
an ion-conducting composite according to claim 27 as an electrolyte, the ion-conducting composite being sandwiched between facing electrodes.

31. An electrochemical device comprising:
an electrochemical reaction section formed by sandwiching a hydrogen-ion-conducting composite according to claim 27 as an electrolyte between facing electrodes.

32. The electrochemical device according to claim 31, wherein
the electrochemical device is configured as a fuel cell.
